(19) United States
(12) Patent Application Publication
(10) Pub. No.: US 2026/0042484 A1
(43) Pub. Date: Feb. 12, 2026

(54) SEPARABLE AND COUPLABLE SMART MOBILITY

(71) Applicants: Hyundai Motor Company, Seoul (KR); Kia Corporation, Seoul (KR)

(72) Inventors: Gook Hyun JEON, Hwaseong-si (KR); Won Ki SONG, Hwaseong-si (KR); Ki Hyun CHOI, Hwaseong-si (KR); Dong Hwan LIM, Hwaseong-si (KR); Soo Bok KIM, Hwaseong-si (KR); Jae Seung LEE, Hwaseong-si (KR)

(73) Assignees: Hyundai Motor Company, Seoul (KR); Kia Corporation, Seoul (KR)

(21) Appl. No.: 19/024,838

(22) Filed: Jan. 16, 2025

(30) Foreign Application Priority Data
Aug. 6, 2024 (KR) 10-2024-0104926

(51) Int. Cl. B62D 21/14; B60R 16/023; B62D 25/20; B62D 29/00; B62D 63/04

(52) U.S. Cl. CPC B62D 21/14; B60R 16/0231; B62D 25/2009; B62D 29/00; B62D 63/04

(57) ABSTRACT

A separable and couplable smart mobility of the present disclosure is configured to expand or contract. When contracted, multiple frames overlap each other to ensure overall rigidity, and when expanded, an opening part of a vehicle body opens to allow passengers to board the same, thereby eliminating the need for separate door partitioning and securing a wider entrance. Moreover, even when the mobility is contracted, it is easy to manufacture the mobility since there is no door partitioning for passenger boarding and alighting, and even when the overall size of the mobility is small, the size of the entrance is secured, improving user convenience.

### CROSS-REFERENCE TO RELATED APPLICATION(S)

This application is based on and claims priority under 35 U.S. C. 119 to Korean Patent Application No. 10-2024-0104926, filed on Aug. 6, 2024, in the Korean Intellectual Property Office, the disclosure of which is herein incorporated by reference in its entirety.

### BACKGROUND OF THE INVENTION

### 1. Field of the Invention

The present disclosure relates to a separable and couplable smart mobility that is configured to expand or contract and allows passengers to board when expanded.

### 2. Description of the Prior Art

Recently, urban air mobilities (UAMs), purpose built vehicles (PBVs), and mobility hubs (mobility transfer centers) have been attracting attention as future autonomous transportation solutions, leading to the introduction of various concepts and the commencement of preliminary technological developments in these areas.

In particular, the PBVs are ground transportation systems based on electric vehicles, and move not by vehicle wheels, but by electric wheels that move freely 360 degrees. The PBVs go beyond simple transportation means and provide customized services needed by passengers while traveling to their destinations. The PBVs may be designed to reflect incorporate personalized features and used as various spaces, ranging from leisure spaces, such as restaurants, cafes, or hotels, to essential social facilities such as hospitals and pharmacies, as well as functioning as urban shuttles. To this end, the interiors of vehicle bodies may be customized using modular products tailored to purposes.

However, a mobility including a PBV has a complex manufacturing process due to the numerous components constituting the vehicle body. That is, molds should be manufactured for the production of a body constituting the vehicle body, numerous welding and assembly processes are included, and production lines should be configured for each process.

In particular, as PBVs are designed to reflect personalization trends and cater to diverse preferences, challenges arise in manufacturing doors for passenger boarding and alighting. For example, in order to manufacture a door, the opening and closing structure is created by partitioning the exterior of the vehicle body, but this partitioning reduces rigidity and causes interference with other components.

The foregoing description of the background art is intended solely to aid in understanding the context of the present disclosure, and is not intended to mean that the present disclosure falls within the purview of the related art already known to those skilled in the art.

### SUMMARY OF THE INVENTION

The present disclosure provides a separable and couplable smart mobility that is configured to expand or contract, in which the interior is closed when contracted, and an entrance is provided when expanded to allow passengers to board the same, while ensuring overall rigidity.

The technical subjects addressed in the present disclosure are not limited to those mentioned above, and other technical subjects not explicitly stated may be readily understood from the following descriptions by those skilled in the art to which the present disclosure pertains. In view of the foregoing, a separable and couplable smart mobility according to the present disclosure includes: a vehicle body having an interior space and an opening part located on one or both sides of the vehicle body; a driving unit including a closure part and a driving module, wherein the closure part is configured to match the opening part of the vehicle body, and the driving module is installed to the closure part and is configured to move the driving unit; multiple fixed frames located on an inner or outer surface of the vehicle body and extending in a longitudinal direction; extension frames detachably connected to the closure part, wherein each extension frame is connected to a corresponding fixed frame and configured to slide along the fixed frame; and fixing units configured to selectively secure the extension frames to the closure section when the extension frames are located to come into contact with the closure part.

The vehicle body includes an opening part on one side, and a vehicle body driving module is located on the opposite side of the vehicle body. The multiple fixed frames are spaced apart from each other along the periphery of an inner surface of the vehicle body and each have a hollow bore in the longitudinal direction, and
the extension frames are provided in the same number as the fixed frames and each extend in the longitudinal direction to be inserted into the hollow bore.

The extension frames have a length equal to or larger than that of the fixed frames, so that, when the extension frames are inserted into the hollow bores, end portions of the extension frames are partially exposed from the fixed frames.

The extension frames further include a slider connected to the fixed frames and designed to reciprocate linearly along them. The slider is equipped with a sliding or rolling function. Each of the fixed frames includes: a main support portion extends in the longitudinal direction, fixed to the vehicle body, and having a hollow bore; and a sub-support portion extending in a peripheral direction of the vehicle body from the main support portion and fixed to the vehicle body.

The fixing units each include a fixing part and a connecting part. The fixing part is provided in one of the closure frame or a corresponding extension frame, and the connecting part includes: a pole part provided in the other of the closure part and the extension frame; a first magnet rotatably provided in the pole part; a second magnet spaced apart from the first part and fixed to the pole part; and an electromagnet configured to generate a magnetic force when current is applied thereto.

The fixing part is made of a magnetically attractable material, including a steel material, and the first magnet and the second magnet are each configured with a permanent magnet, so that the direction of a magnetic field changes depending on the rotation position of the first magnet.

The electromagnet is provided between the first magnetic and the second magnetic in the pole part, and is configured to adjust the rotation position of the first magnetic through the generation of magnetic force.

During the generation of magnetic force, the electromagnet creates opposite polarities in a direction where the first magnet and the second magnet face from each other.

The fixing units each include: a first contact and a second contact provided on the fixing part and the extension frame, respectively; a pole unit including a first pole part provided with a first permanent magnet and extending toward the first contact and a second pole part extending toward the second contact, wherein a second permanent magnet is rotatably provided on the first pole part, and a third permanent magnet is rotatably provided in the second pole part; a first electromagnet disposed between the first permanent magnet and the second permanent magnet and configured to generate a magnetic force depending on whether current is applied thereto; and a second electromagnet disposed between the first permanent magnet and the third permanent magnet and configured to generate a magnetic force depending on whether current is applied thereto.

The first and second contacts are made of a material magnetically attractable to the permanent magnets, such as steel. The pole unit further includes a partition wall provided between the first pole part and the second pole part, and the partition wall is configured to separate the first and second pole parts from the second and third permanent magnets, respectively.

The first electromagnet is configured to form different polarities in a direction where the first permanent magnet and the second permanent magnet face each other during the generation of magnetic force, and the second electromagnet is configured to form different polarities in a direction where the first permanent magnet and the third permanent magnet face each other during the generation of magnetic force.

A guide extending toward the opening part is provided to the lower portion of the vehicle body, and the driving unit has a floor provided to the lower portion of the closure part, and the floor is connected to the guide portion and configured to move along the guide.

The smart mobility also includes a controller that manages the driving unit and the fixing unit. The controller is designed to control the driving unit and the fixing units to open the vehicle body's opening part based on whether a user is boarding or alighting. The controller is configured to: receive information regarding the user's boarding or alighting direction via communication with a sensor provided on the vehicle body or the user; and control, during the user's boarding or alighting, the fixing unit securing the extension frame located in the user's boarding or alighting direction among the multiple extension frames to release the fixation of the corresponding extension frame, and control the driving unit to move away from the vehicle body.

The controller is configured to: collect information regarding tilt or driving speed of the vehicle body, or presence of a surrounding obstacle via communication with an exterior or a sensor provided on the vehicle body; and ensure that the opening part of the vehicle body remains in a closed state if any of the following conditions are met: the tilt of the vehicle body is at or above a set angle, the driving speed of the vehicle is at or above a set speed, or the surrounding obstacle is present.

The controller is configured to: collect information regarding tilt or speed of the vehicle body, or presence of a surrounding obstacle via communication with an exterior or a sensor provided on the vehicle body; and derive a distance by which the driving unit moves away from the vehicle body based on each piece of information.

The controller is configured to: determine whether the vehicle body is positioned at a station during the separation of the vehicle body and the driving unit; and control, when the vehicle body is identified to be positioned at the station, all of the fixing units to release fixation, and control the driving unit to disengage from the vehicle body.

The separable and couplable smart mobility having the above-described structures is configured to expand or contract. When contracted, the multiple frames overlap each other to ensure overall rigidity, and when expanded, the opening part of the vehicle body opens to allow passengers to board the same, thereby eliminating the need for separate door partitioning and securing a wider entrance.

Moreover, even when the mobility is contracted, it is easy to manufacture the mobility since there is no door partitioning for passenger boarding and alighting, and even when the overall size of the mobility is small, the size of the entrance is secured, improving user convenience.

Advantageous effects obtainable from the present disclosure are not limited to the above-mentioned effects, and other effects which are not mentioned may be clearly understood from the following descriptions by those skilled in the art to which the present disclosure pertains.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating a separable and couplable smart mobility according to an embodiment of the present disclosure;

FIG. 2 is a diagram illustrating an open state of the separable and couplable smart mobility illustrated in FIG. 1;

FIG. 3 is a diagram illustrating the opening and closing operation of the separable and couplable smart mobility illustrated in FIG. 1;

FIG. 4 is a diagram illustrating the states of extension frames depending on whether the extension frames are fixed by a fixing unit or not in the present disclosure;

FIG. 5 is a detailed view of a fixed frame according to an embodiment of the present disclosure;

FIG. 6 is a diagram illustrating the connection of a fixed frame and an extension frame according to an embodiment of the present disclosure;

FIG. 7 is a diagram illustrating a fixing unit according to an embodiment;

FIG. 8 is a diagram illustrating the operation of the fixing unit according to an embodiment;

FIG. 9 is a diagram illustrating a fixing state of the fixing unit according to an embodiment;

FIG. 10 is a diagram showing a fixing unit according to another embodiment;

FIG. 11 is a top plan view of the fixing unit according to another embodiment;

FIG. 12 is a diagram illustrating the operation according to the magnetic application of a first electromagnet in the fixing unit according to another embodiment;

FIG. 13 is a diagram illustrating the fixing state by the first electromagnet in the fixing unit according to another embodiment;

FIG. 14 is a diagram illustrating the operation according to the magnetic application of a second electromagnet in the fixing unit according to another embodiment;

FIG. 15 is a diagram illustrating the fixing state by the second electromagnet in the fixing unit according to another embodiment;

FIG. 16 is a cross-sectional front view of a separable and couplable smart mobility according to the present disclosure;

FIG. 17 is a cross-sectional side view of a separable and couplable smart mobility according to the present disclosure;

FIG. 18 is a diagram illustrating a mode implemented according to the direction of a passenger in a separable and couplable smart mobility according to the present disclosure;

FIG. 19 is a diagram illustrating a mode implemented according to the direction of a passenger in a separable and couplable smart mobility according to the present disclosure; and

FIG. 20 is a diagram illustrating a separation mode of a separable and couplable smart mobility according to the present disclosure.

### DETAILED DESCRIPTION OF THE EXEMPLARY EMBODIMENTS

In describing the embodiments presented herein, a detailed description of known functions or configurations incorporated herein will be omitted when it is determined that the description may make the subject matter of the embodiments set forth herein unclear. Additionally, the accompanying drawings are provided solely to aid in understanding the embodiments presented herein. The technical concept of the present disclosure is not limited to the accompanying drawings but includes all modifications, equivalents, and alternatives within the spirit and scope of the disclosure. Terms including an ordinal number such as “a first” and “a second” may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

The terms “module” and “unit” used for the elements in the following description are given or interchangeably used in consideration of only the ease of writing the specification, and do not have distinct meanings or roles by themselves.

If an element is described as “connected” or “coupled” to another element, it should be understood that the connection may be direct or indirect, with another element possibly existing in between. Conversely, if an element is described as “directly connected” or “directly coupled” to another element, it should be understood that no other element is present in between.

A controller may include a communication device configured to communicate with a sensor or another control unit, a memory configured to store an operation system, a logic command, or input/output information, and at least one processor configured to perform determination, calculation, decision or the like which are required for responsible function controlling.

Hereinafter, embodiments set forth herein will be described in detail with reference to the accompanying drawings, and the same or similar elements are given the same and similar reference numerals regardless of figure numbers, so duplicate descriptions thereof will be omitted.

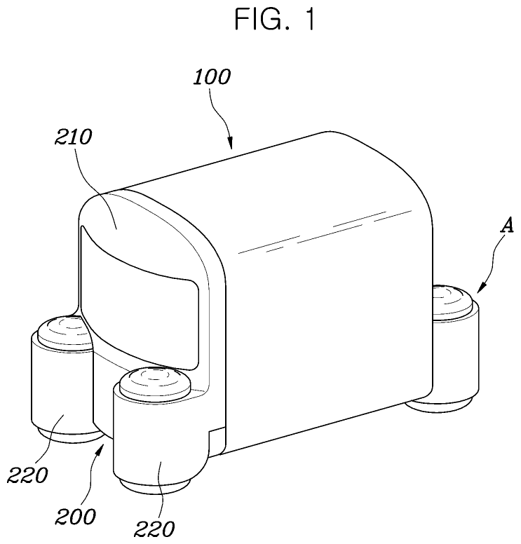

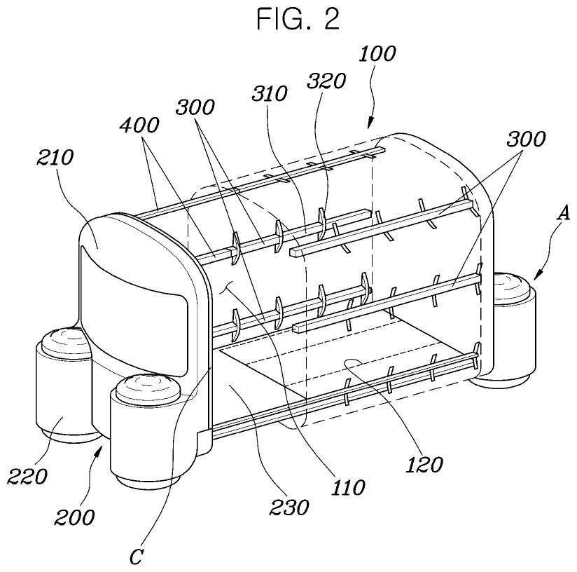

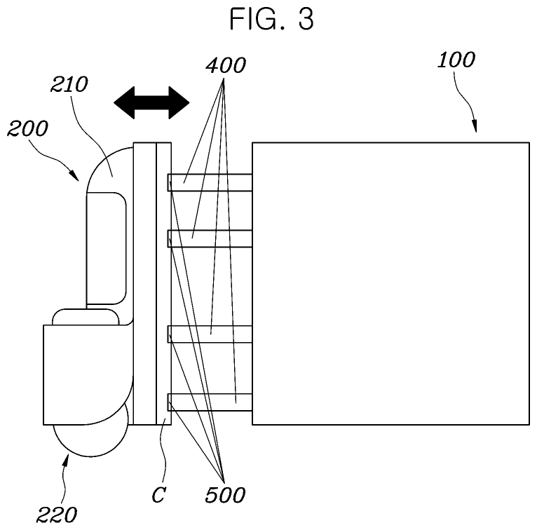

As illustrated in FIGS. 1 to 4, a smart mobility according to the present disclosure comprises: a vehicle body 100 having an interior space and an opening part 110 formed on one or both sides; a driving unit 200 including a closure part 210 and a driving module 220 installed to the closure part 210, the closure part 210 being configured to match the opening part 110 of the vehicle body 100, and the driving module 220 being configured to move the driving unit 200; multiple fixed frames 300 provided on the inner or outer surface of the vehicle body 100 and extending in a longitudinal direction; multiple extension frames 400 detachably connected to the closure part 210, wherein each extension frame is connected to a corresponding fixed frame 300 and configured to slide along the fixed frame 300; and a fixing unit 500 configured to allow the extension frames 400 to be selectively fixed while the extension frames 400 are positioned to be in contact with the closed part 210.

The vehicle body 100 may include an outer plate b-1 and an inner plate b-2, and the outer plate b-1 and the inner plate b-2 each of which may have an external shape determined through processes such as roll forming based on user needs. The outer plate b-1 and the inner plate b-2 of the vehicle body 100 may be assembled in a sliding manner.

The vehicle body 100 has an interior space, and the opening part 110 is provided on one or both sides, allowing the interior and exterior to communicate through the opening part 110. Here, the opening part 110 may serve as an entrance, and by opening one or both sides of the vehicle body 100 to form the opening part 110, the manufacturing of the vehicle body 100 may become easier. In addition, since the size of the opening part 110 is secured in proportion to the size of the vehicle body 100, the convenience of passenger boarding and alighting through the opening part 110 may be improved.

The driving unit 200 includes a closure part 210 and a driving module 220. The driving unit 200 may be configured as a device capable of determining a moving direction and moving by itself, either with or without user operation. For example, the driving unit 200 may be an autonomous vehicle, an autonomous mobile robot, or the like.

The driving unit 200 is designed so that the closure part 210 aligns with the opening part 110 of the vehicle body 100. When the driving unit 200 moves toward the opening part 110, the closure part 210 closes the opening part 110. The closure part 210, when coupled to the opening part 110 of the vehicle body 100, forms the front or rear portion of the mobility. In addition, the external shape of the closure part 210 may be determined to match the mobility's design, and it may include various convenience features, such as a glass member.

A driving module 220 is provided at the lower portion of the closure part 210, and the driving module 220 is means for moving the vehicle body 100 and may be configured in various ways, such as an electric wheel or walking mechanism. The driving module 220 may include components such as a motor or engine that provides power to the moving means, and a steering device or a steering wheel that adjusts the direction of the moving means.

In particular, in the present disclosure, the fixed frames 300 are provided in the vehicle body 100, the extension frames 400 are provided in the closure part 210 of the driving unit 200, and the extension frames 400 are connected to the fixed frames 300 in a slidable manner. In other words, the fixed frames 300 extends longitudinally within the vehicle body 100, and the extension frames 400 are also provided to extend longitudinally along the fixed frames 300. Here, the term “longitudinal direction” refers to the left-right direction in FIG. 1, and may be the direction in which the opening part 110 of the vehicle body 100 is formed or the opposite direction. To the connection structure in which the extension frames 400 slide along the fixed frames 300, various connection structures, such as a groove/protrusion structure, may be applied.

Through the fixed frames 300 and the extension frames 400, the vehicle body 100 and the driving unit 200 can maintain a connected state, and depending on the movement position of the driving unit 200, the fixed frames and the extension frames may be spaced apart or separated from the vehicle body 100. Through this mechanism, when the driving unit 200 is separated from the vehicle body 100, the opening part 110 of the vehicle body 100 is exposed, allowing passengers to board and alight, and when the driving unit 200 comes into contact with the vehicle body 100, the opening part 110 of the vehicle body 100 is closed, preventing the interior space from being exposed to the exterior.

Meanwhile, the present disclosure includes a fixing unit 500 that is provided for fixing or releasing the closure part 210 of the driving unit 200 and the extension frames 400. Multiple fixing units 500 may be provided to match with the multiple extension frames 400, respectively. When the extension frames 400 and the closure part 210 are connected by the fixing units 500, the extension frames 400 become exposed in a form that extend from the vehicle body 100 depending on the movement position of the driving unit 200. When the connection between the extension frames 400 and the closure part 210 is released by the fixed frames 300, the extension frames 400 remain retracted inside the vehicle body 100, allowing passengers to board and alight from the corresponding area.

The fixing units 500 may be installed to the closure part 210 via a coupler C provided in the closure part 210 of the driving unit 200. The coupler C is configured to provide a space for installing the fixing units 500 within the closure part 210 and is applicable in various forms depending on the shape of the closure part 210.

Accordingly, in the present disclosure, when the driving unit 200 moves toward the vehicle body 100, the opening part 110 of the vehicle body 100 closes. Conversely, when the driving unit 200 moves away, the opening part 110 opens. In other words, in the state in which the fixing units 500 fix the closure part 210 of the driving unit 200 and the extension frames 400, if the driving unit 200 moves away from the vehicle body 100, the extension frames 400 are deployed and extend from the vehicle body 100 while moving together with the driving unit 200. In this way, the vehicle body 100 and the driving unit 200 are connected via the extension frames 400, and passenger boarding and alighting are blocked at the positions where the extension frames 400 are located.

Meanwhile, in the state in which the fixing units 500 release the fixing between the closure part 210 of the driving unit 200 and the extension frames 400, when the driving unit 200 moves away from the vehicle body 100, the extension frames 400 remain inserted in the fixed frames 300, thereby being undeployed from the vehicle body 100. As a result, when the driving unit 200 is separated from the vehicle body 100, passengers can board and alight through the position where the extension frames 400 remain undeployed.

Specifically, in the present disclosure, the vehicle body 100 includes an opening part 110 on one side, while a vehicle body driving module A may be located on the side opposite the opening part 110. As illustrated in FIG. 1, the vehicle body 100 may be include the opening part 110 on only one side while being closed on the opposite side, and the vehicle body driving module A may be installed on the opposite side of the opening part 110.

Consequently, the vehicle body 100 can be moved via the driving unit 200 and the vehicle body driving module A. The driving module 220 of the driving unit 200 and the vehicle body driving module A may be configured to have the same specifications, and may communicate with each other to not only control the driving direction but also adjust the distance between the driving unit 200 and the vehicle body 100. For example, when the driving unit 200 and the vehicle body driving module A travel at the same speed, the interior space of the vehicle body 100 remains closed, and when the driving unit 200 and the vehicle body driving module A travel away from each other, the driving unit 200 can be separated from the vehicle body 100.

Providing an opening part 110 on one side of the vehicle body 100 as described is merely an example. Opening parts 110 may be provided on both sides of the vehicle body 100, with driving units 200 corresponding to each opening part 110.

Meanwhile, the multiple fixed frames 300 are spaced apart from each other along the inner periphery of the vehicle body 100 and are provided with longitudinal hollows. The extension frames 400 may correspond in number to as the fixed frames 300 and may extend longitudinally to be inserted into the hollow bores, respectively.

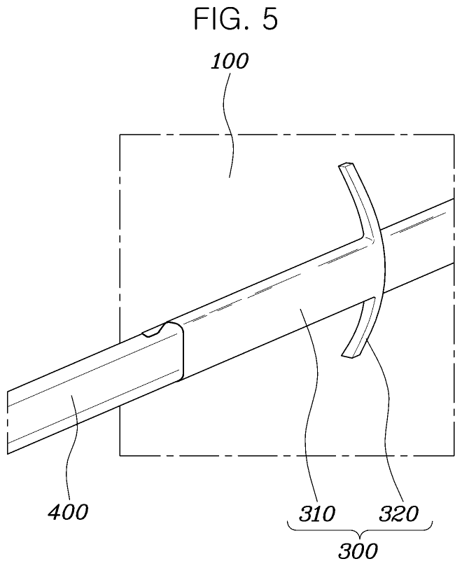

As illustrated in FIGS. 1 and 5, the multiple fixed frames 300 are spaced apart from each other along the inner periphery of the vehicle body 100, and the multiple extension frames 400 are similarly spaced apart from each other along the periphery of the closure part 210 of the driving unit 200 at the same intervals as the fixed frames 300. As a result, when the vehicle body 100 and the driving unit 200 are connected via the fixed frames 300 and the extension frames 400, structural connection rigidity and balance are ensured.

Additionally, because the multiple fixed frames 300 and extension frames 400 are spaced apart, the number and positions of the extension frames 400 deployed from the fixed frames 300 can vary, altering the accessible entry point to the opening part 110 from the exterior. Meanwhile, the fixed frames 300 extend longitudinally and have hollows, while the extension frames 400 also extend longitudinally and are inserted into the inner sides of the fixed frames 300, allowing the extension frames 400 to slide and move in a linear motion within the fixed frames 300.

As a result, when the extension frames 400 are fixed to the driving unit 200 by the fixing units 500, the extension frames 400 may move within the fixed frames 300 depending on the movement position of the driving unit 200, and the extension frames 400 may either deploy from the vehicle body 100 or retract into the fixed frames 300 depending on the position of the driving unit 200.

Meanwhile, each extension frame 400 may include slider 410 connected to a fixed frame 300, allowing the extension frame to reciprocate linearly along the fixed frame 300, and the slider 410 may be equipped with a sliding or rolling function.

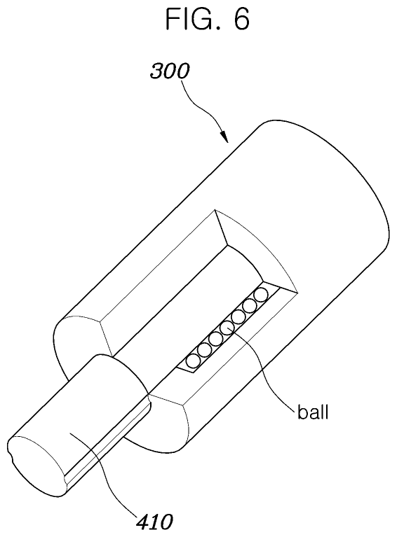

For example, as illustrated in FIG. 6, the slider 410 may be configured in the form of a ball bearing with balls inside, and when the slider 410 is connected to the fixed frame 300, the extension frame 400 may move smoothly within the fixed frame 300 while multiple balls perform a rolling action.

In addition to the rolling function, the slider 410 may be configured to slide using the low friction structure. In this way, the extension frame 400 can be connected to the fixed frame 300 via the slider 410, and as the slider 410 moves in a sliding or rolling manner within the fixed frame 300, the extension frame 400 can slide within the fixed frame 300.

Meanwhile, the extension frame 400 may have the same length as or longer than the fixed frame 300, so that, when the extension frame 400 is inserted into the hollow bore of the fixed frame 300, one end can be partially exposed from the fixed frame 300.

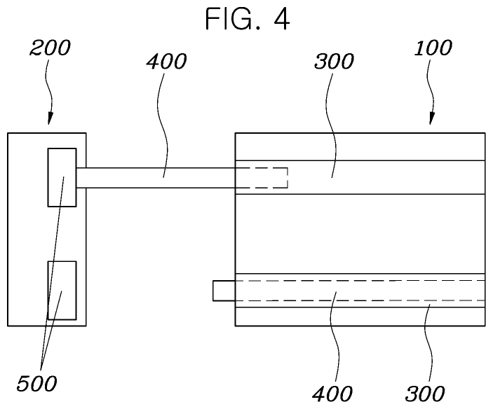

Referring to FIG. 4, the extension frame 400 either extends outward from the vehicle body 100 as it slides out of the fixed frame 300 or retracts to be overlappingly accommodated within the fixed frame 300. Here, when the driving unit 200 is disposed to be in contact with the vehicle body 100, the extension frame 400 should be fixed to the driving unit 200 via the fixing unit 500. Accordingly, even when overlappingly accommodated within the fixed frame 300, the extension frame 400 partially remains exposed outside the vehicle body 100, allowing the fixing unit 500 and the extension frame 400 to be interconnected while the driving unit 200 is disposed in contact with the vehicle body 100.

Meanwhile, the fixed frame 300 may include a main support portion 310 having a hollow bore, extending longitudinally, and fixed to the vehicle body 100, and a sub-support portion 320 extending circumferentially from the main support 310 and fixed to the vehicle body 100.

In this configuration, the fixed frame 300 may include the main support portion 310 and the sub-support portion 320, where the sub-support portion 320 radially extends from opposite sides of the main support portion 310. The main support portion 310 may also be thicker than the sub-support portion 320. As a result, the fixed frame 300 is supported by the sub-support portion 320 extending bilaterally from the main support portion 310, preventing the fixed frame 300 from tilting relative to the vehicle body 100. In addition, the main support portion 310 and the sub-support portion 320 are firmly coupled to the vehicle body 100, providing structural stability, and even when the extension frame 400 is inserted into the hollow bore of the fixed frame 300, a stable support structure is achieved.

Meanwhile, the fixing unit 500 according to the present disclosure may be applied in various embodiments.

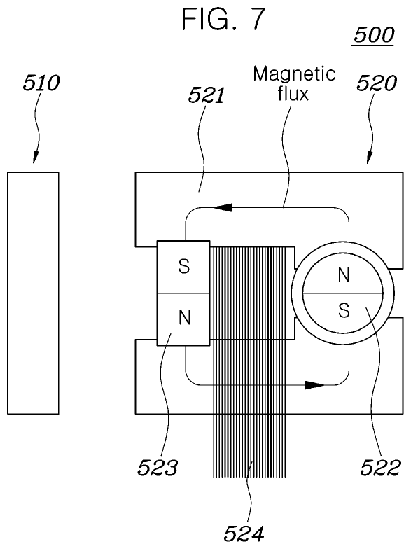

In an embodiment, as illustrated in FIGS. 7 to 9, the fixing unit 500 may include a fixing part 510 and a connecting part 520.

Here, the fixing part 510 may be provided on one of the closure part 210 and the extension frame 400, while the connecting part 520 may be provided on the other of the closure part 210 and the extension frame 400. In the present disclosure, it is assumed that the fixing part 510 is provided on the extension frame 400, and the connecting part 520 is provided on the closure part 210 of the driving part 200, but the installation positions of the fixing part 510 and the connecting part 520 may be configured to be mutually opposite. However, because the connecting part 520 requires current to operate the electromagnet 524, it may be installed on the driving unit 200.

The fixing part 510 may be made of a magnetically attractable material including a steel material. The fixing part 510 may be provided at an end of each extension frame 400.

The connecting part 520 includes a pole part 521 made of a magnetically attractable material, a first magnet 522 rotatably provided on the pole part 521, a second magnet 523 fixed to the pole part 521 at a distance from the first magnet 522, and the electromagnet 524 that generates magnetic force when current is applied thereto.

The pole part 521 has a pair of end portions in its cross-section and magnetic flux is generated at each end portion, allowing the end portion to be coupled to a counterpart component by magnetic force. For example, the pole part 521 may have a cylindrical or polygonal shape with an internal space, and the first magnet 522 and the second magnet 523 may be provided inside the internal space. The magnetic flux may be formed in the pole part 521 by the first magnet 522 and the second magnet 523, and the direction of the magnetic flux may be determined depending on the rotation position of the first magnet 522.

The first magnet 522 and the second magnet 523 may be permanent magnets. As a result, when the fixing part 510 and the pole part 521 come into contact with each other, the magnetic flux is generated to pass from the pole part 521 through the fixing part 510, allowing the fixing part 510 and the pole part 521 to be magnetically coupled to each other.

Meanwhile, the first magnet 522 is provided to be rotatable in the pole part 521, and the electromagnet 524 is provided between the first magnet 522 and the second magnet 523 in the pole part 521 to adjust the rotation position of the first magnet 522 by generating magnetic force.

That is, when current is applied to the electromagnet 524, polarities are acquired, and the first magnet 522 reacts to the polarity of the electromagnet 524, changing its rotation position through attractive and repulsive forces. As the first magnet 522 rotates, the magnetic flux between the first magnet 522 and the second magnet 523 may change, and through this change in magnetic flux, the pole part 521 may be selectively fixed to the fixing part 510.

When the electromagnet 524 generates magnetic force, opposite polarities form in the direction where the first magnet 522 and the second magnet 523 face each other. For instance, the electromagnet 524 may exhibit an S-pole toward the first magnet 522 and an N-pole toward the second magnet 523. Specifically, the directions of the N-pole and S-pole of the first magnet 522 are switched depending on its rotation position. As the second magnet 523 is fixed to the pole part 521, the positions of its N-pole and S-pole are fixed.

Here, as illustrated in FIG. 7, when the polarities of the first magnet 522 and the second magnet 523 are arranged to intersect, the magnetic flow is formed to pass through the first magnet 522 and the second magnet 523. That is, since the magnetic flow is formed only within the pole part 521, the pole part 521 may be in an unjoined state even when it comes into contact with the fixing part 510.

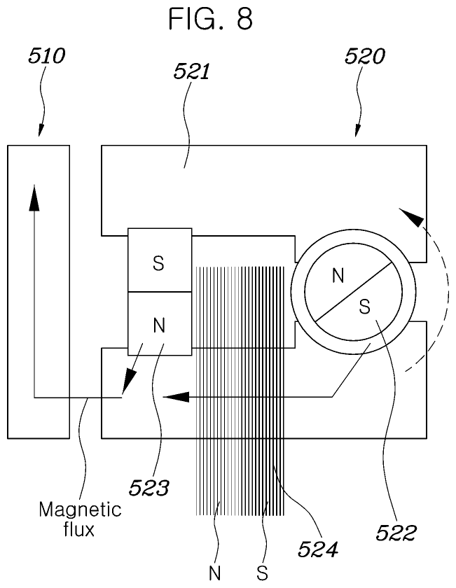

Here, as illustrated in FIG. 8, when current is applied to the electromagnet 524 and a magnetic force is generated, the first magnet 522 rotates by the magnetic force of the electromagnet 524. For example, when the S-pole and N-pole of the second magnet 523 are positioned at the top and bottom, respectively, and the electromagnet 524 establishes the S-pole toward the first magnet 522 and the N-pole toward the second magnet 523, the first magnet 522 is rotated due to the forces of attraction and repulsion in response to the S-pole of the electromagnet 524.

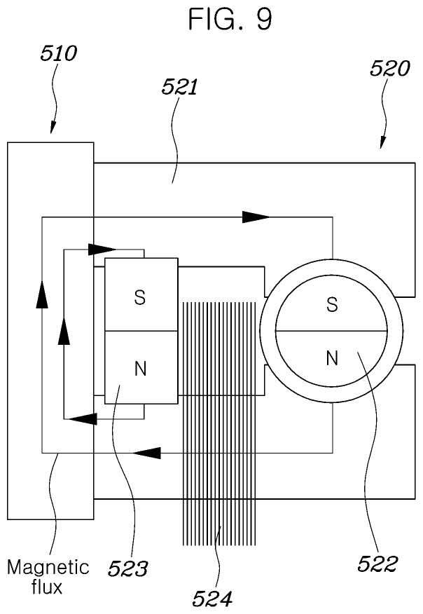

Therefore, as illustrated in FIG. 9, as the first magnet 522 rotates and the polarity of the first magnet 522 and the polarity of the second magnet 523 are matched, magnetic flux is generated in the pole part 521. As the magnetic field is formed in a direction passing through the pole part 521 and the fixing part 510 joined to the pole part 521, the pole part 521 and the fixing part 510 being in a joined state for consistency.

At this time, even if the current is not applied to the electromagnet 524 and polarities are not generated, the joined state of the fixing part 510 and the pole part 521 may be maintained as the polarities of the first magnet 522 and the second magnet 523 are matched.

The joined state obtained through the fixing unit 500 according to an embodiment may be released by causing the electromagnet 524 to form polarities opposite to those formed when the fixing part 510 and the pole part 521 are joined. That is, by rotating the first magnet 522 by the electromagnet 524 so that the polarities of the first magnet 522 and the second magnet 523 intersect, the joined state between the pole part 521 and the fixing part 510 can be released.

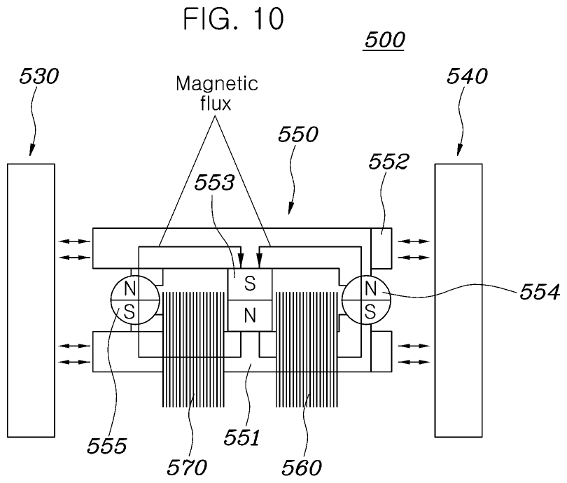

Meanwhile, FIG. 10 is another embodiment of the fixing unit 500.

Here, the fixing unit 500 includes a first contact 530 and a second contact 540 provided on the fixing part 510 and the extension frame 400, respectively.

The first contact 530 is provided on the fixing unit 500, and the second contact 540 is provided on the extension frame 400, and each contact may be made of a material magnetically attractable to each permanent magnet, including a steel material.

The first contact 530 and the second contact 540 may be configured integrally with the fixing unit 500 and the extension frame 400, respectively, and may be manufactured separately and then bonded to the fixing unit 500 and the extension frame 400.

Meanwhile, the fixing unit 500 includes a pole unit 550 that is joined to the first contact 530 and the second contact 540.

The pole unit 550 includes a first pole part 551 and a second pole part 552, and the first pole part 551 and the second pole part 552 are spaced apart from each other. The first pole part 551 is configured to come into contact with the first contact 530, and the second pole part 552 is configured to come into contact with the second contact 540.

Here, the pole unit 550 may further include a partition wall 580 positioned between the first pole part 551 and the second pole part 552.

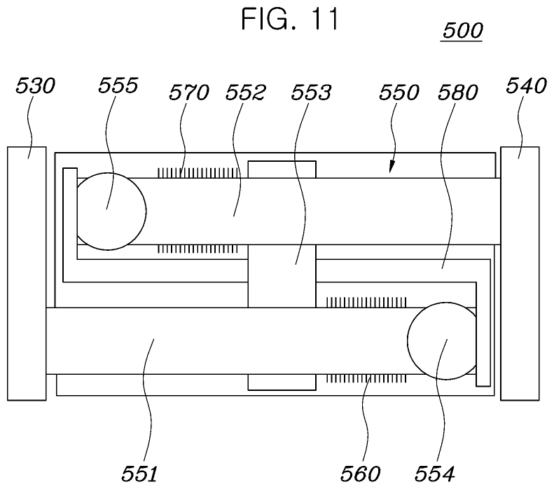

As illustrated in FIG. 11, the partition wall 580 may be disposed to separate the first pole part 551 and the second pole part 552, separate the second permanent magnet 554 and the third permanent magnet 555, and separate the first electromagnet 560 and the second electromagnet 570. The partition wall 580 may be made of a material that is not affected by magnetic force. The partition wall 580 minimizes changes in magnetic flux due to interference between magnetic fields in each pole part 521, each permanent magnet 554 or 555, and each electromagnet 560 or 570. Furthermore, since the magnetic flux through each pole unit 521 is generated only in a predetermined path by the partition wall 580, the design of magnetic flow is possible without increasing the size of the first permanent magnet 553.

The first permanent magnet 553 is provided to be in contact with the first pole part 551 and the second pole part 552, and in the present disclosure, it is assumed that one first permanent magnet 553 is connected to both the first pole part 551 and the second pole part 552. The first permanent magnet 553 may be provided in each of the first pole part 551 and the second pole part 552.

Meanwhile, the second permanent magnet 554 is rotatably provided in the first pole part 551, the third permanent magnet 555 is rotatably provided in the second pole part 552, the first electromagnet 560 is positioned between the first permanent magnet 553 and the second permanent magnet 554, and the second electromagnet 570 is disposed between the first permanent magnet 553 and the third permanent magnet 555.

Through this, when current is applied to the first electromagnet 560 to generate a magnetic force, the second permanent magnet 554 may rotate by the magnetic force of the first electromagnet 560, and when current is applied to the second electromagnet 570 to generate a magnetic force, the third permanent magnet 555 may rotate by the magnetic force of the second electromagnet 570.

That is, when the second permanent magnet 554 rotates due to changes in polarities of the first electromagnet 560, the magnetic flux between the first permanent magnet 553 and the second permanent magnet 554 may change, and when the third permanent magnet 555 rotates due to changes in polarities of the second electromagnet 570, the magnetic flux between the first permanent magnet 553 and the third permanent magnet 555 may change. As a result, the magnetic forces are generated in the first pole part 551 and the second pole part 552 by the first electromagnet 560 and the second electromagnet 570, respectively, the first pole part 551 may be selectively joined to the first contact 530, and the second pole part 552 may be selectively joined to the second contact 540.

During magnetic force generation, the first electromagnet 560 of the present disclosure forms different polarities in the direction where the first permanent magnet 553 and the second permanent magnet 554 face each other, Similarly, the second electromagnet 570 forms opposite polarities in the direction where the first permanent magnet 553 and the third permanent magnet 555 face each other.

In detail, the first permanent magnet 553 is fixed in position in the first pole part 551 and the second pole part 552, and the directions of the N pole and the S pole in each of the pole parts 551 and 552 are switched depending on the rotation positions of the second permanent magnet 554 and the third permanent magnet 555.

Based on this, the connection relationship between the first contact 530 and the first pole part 551 will be explained. As illustrated in FIG. 10, relative to the first permanent magnet portion 553, when each of the polarities of the first permanent magnet 553 and each of the polarities of the second permanent magnet 554 and the third permanent magnet portion 555 are arranged to intersect with each other, magnetic flux is generated between the first permanent magnet 553 and the second permanent magnet 554, and between the first permanent magnet 553 and the third permanent magnet 555. Accordingly, the first pole portion 551 and the second pole portion 552 are unjoined with the first contact 530 and the second contact 540, respectively.

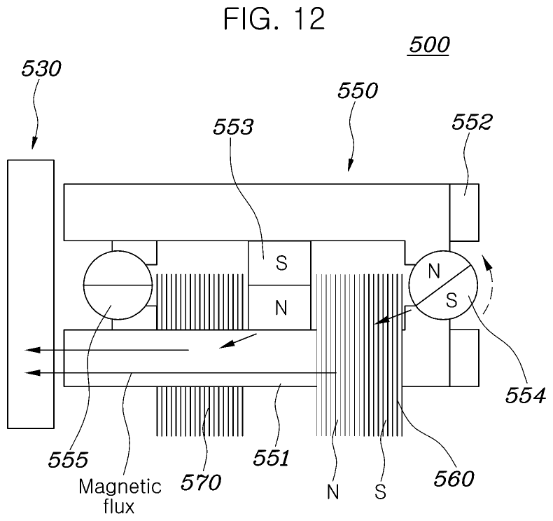

Here, as illustrated in FIG. 12, when current is applied to the first electromagnet 560 and magnetic force is generated, the second permanent magnet 554 rotates in response to the magnetic force of the first electromagnet 560. For example, when the S-pole and N-pole of the first permanent magnet 553 are disposed at the top and bottom, respectively, the first electromagnet 560 establishes the N-pole toward the first permanent magnet 553 and the S-pole toward the second permanent magnet 554, the second permanent magnet 554 rotates due to the forces of attraction and repulsion in response to the S-pole of the first electromagnet 560.

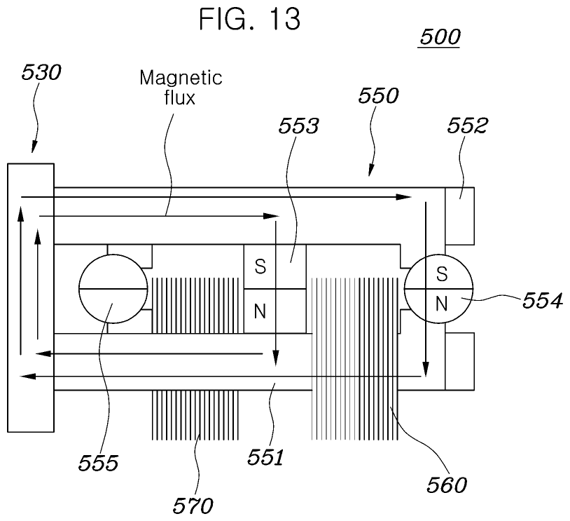

Due to this, as illustrated in FIG. 13, as the second permanent magnet 554 is rotated and the polarities of the second permanent magnet 554 and the first permanent magnet 553 are matched, magnetic flow is generated in the first pole part 551, and as the magnetic field is formed in a direction passing through the first pole part 551 and the first contact 530, the first pole part 551 and the first contact 530 may be joined.

At this time, even when no current is applied to the first electromagnet 560 and thus no polarity is established, the joined state of the first contact 530 and the first pole part 551 may be maintained as the polarities of the first permanent magnet 553 and the second permanent magnet 554 are matched.

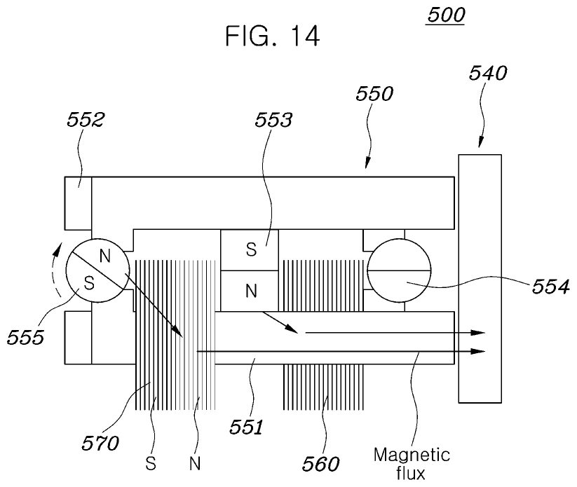

Regarding the connection relationship between the second contact 540 and the second pole part 552, as illustrated in FIG. 14, when current is applied to the second electromagnet 570, generating a magnetic force, the third permanent magnet 555 rotates in response to the magnetic force of the second electromagnet 570. For example, when the S-pole and N-pole of the first permanent magnet 553 are disposed at the top and bottom, respectively, the second electromagnet 570 establishes the N-pole toward the first permanent magnet 553 and the S-pole toward the third permanent magnet 555, the third permanent magnet 555 rotates due to the forces of attraction and repulsion in response to the S-pole of the second electromagnet 570.

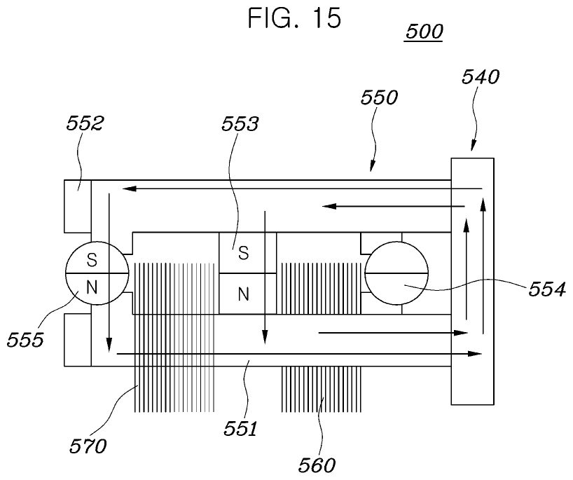

Due to this, as illustrated in FIG. 15, as the third permanent magnet 555 is rotated and the polarities of the third permanent magnet 555 and the first permanent magnet 553 are matched, magnetic flow is generated in the second pole part 552, and as the magnetic field is formed in a direction passing through the second pole part 552 and the second contact 540, the second pole part 552 and the second contact 540 may be joined.

As described above, the fixing unit 500 of the present disclosure may be configured in respective embodiments according to a unidirectional magnetic flux fixing structure and a bidirectional magnetic flux fixing structure.

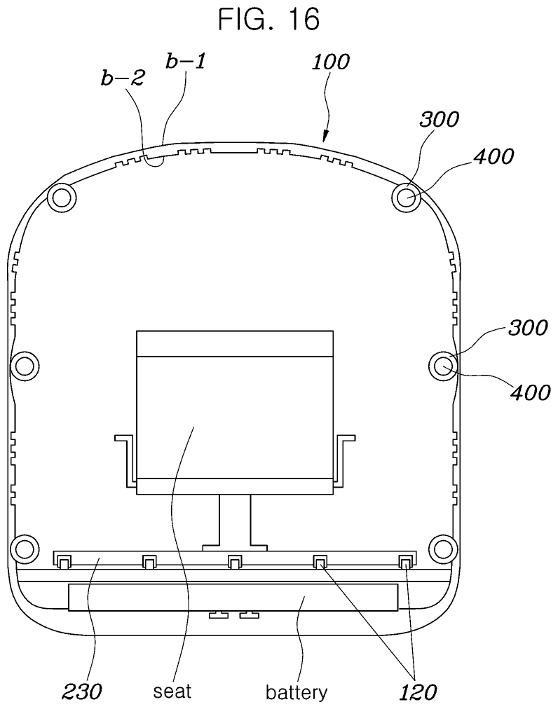

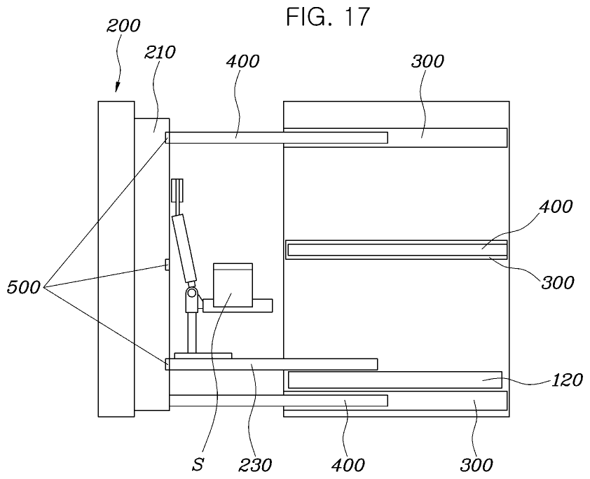

Meanwhile, as illustrated in FIGS. 16 and 17, a vehicle body 100 is provided with a guide 120 extending toward the opening part 110 in the bottom portion, and the driving unit 200 includes a floor 230 in the lower portion of the closure part 210, and the floor part 230 is connected to the guide 120 to move along the guide 120.

The guide 120 may be positioned in the lower portion of the vehicle body 100 and configured as a rail extending toward the opening part 110. The driving unit 200 has the floor 230 in the lower portion of the closure part 210, and the floor 230 is connected to the guide 120 of the vehicle body 100 and configured to move along the guide 120. Accordingly, the floor 230 and the guide 120 may be mutually connected with a rail connection structure. In addition, the floor 230 may be stably connected to the guide 120 by applying a reinforcing structure to support load including passengers. The reinforcing structure may be applied in various forms, including a bearing structure.

Meanwhile, various convenient features including a seat may be provided on the floor 230. That is, the floor 230 serves as a space where passengers may reside when the driving unit 200 is connected to the vehicle body 100, and various convenient features including a seat may be provided on the side of the driving unit 200. Due to this, when the driving unit 200 is separated from the vehicle body 100 to allow passengers to board or alight from the same, a passenger on the floor 230 of the driving unit 200 may move away from the vehicle body 100 and alight together with the driving unit 200, or when boarding the floor 230, a passenger may enter the vehicle body 100 together with the driving unit 200.

The separable and couplable smart mobility described in this disclosure may be controlled for user convenience using a controller 600. The controller 600 is provided to control the driving unit 200 and the fixing unit 500, and depending on the user's boarding or alighting, the controller 600 controls the driving unit 200 and the fixing unit 500 to open the opening part 110 of the vehicle body 100.

That is, the controller 600 determines whether the driving unit 200 is fixed to the vehicle body 100 by controlling the movement position of the driving unit 200 and the fixing unit 500. It then opens or closes the opening part 110 of the vehicle body 100.

In detail, the controller 600 receives information based on the user's boarding or alighting direction through communication with the user or a sensor S installed in the vehicle body 100.

The sensor S may be a camera, lidar, laser, or the like that detects the interior or exterior of the vehicle body 100, and may identify the user's location by communicating through a terminal carried by the user.

Through this, when the user intends to board or alight from the mobility, the controller 600 controls the fixing unit 500 to release the fixation of multiple extension frames 400 located in the passenger boarding or alighting direction among the multiple extension frames 400, and controls the driving unit 200 to move away from the vehicle body 100.

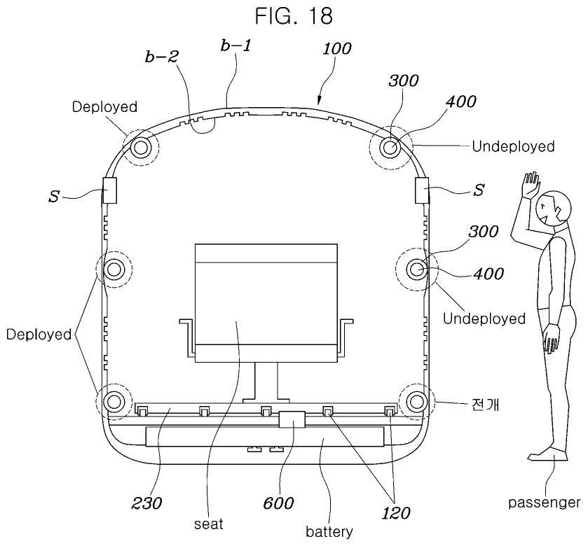

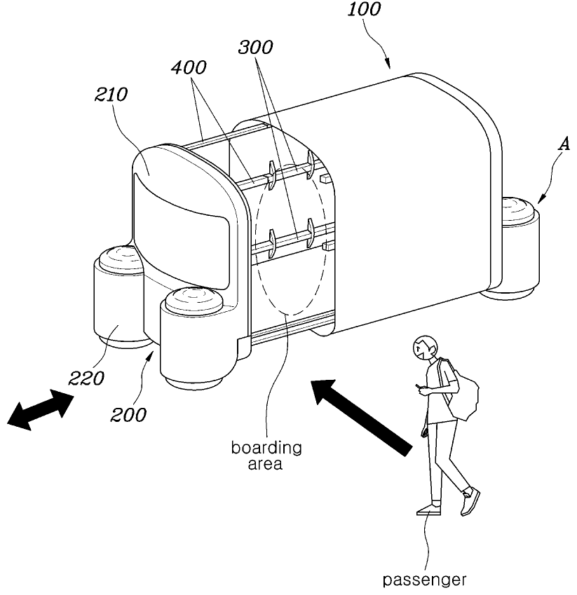

That is, as illustrated in FIGS. 18 and 19, among the multiple extension frames 400 that connect the vehicle body 100 and the driving unit 200, when the extension frames 400 matching the direction of the passenger are released from fixation by the fixing units 500, even if the driving unit 200 moves away from the vehicle body 100, the corresponding extension frames 400 do not extend from the vehicle body 100, and only the remaining extension frames 400 are deployed.

In this way, since the extension frames 400 matching the direction where a passenger is located are not deployed from the vehicle body 100, the passenger can board or alight in the corresponding area, and the remaining extension frames 400 are connected between the vehicle body 100 and the driving unit 200 to form a support structure and thus support the load. Additionally, for users identified in advance, all extension frames 400, except those aligned with the user's position, are deployed. This prevents other users from boarding in areas where the extension frames 400 are deployed and extended. Meanwhile, the controller 600 may collect information regarding the tilt or driving speed of the vehicle body 100, or the presence of surrounding obstacles through a sensor S provided in the vehicle body 100 or via external communication.

Here, the sensor S may include any one of a tilt sensor, a camera, a lidar, a laser, a gravity sensor, and a speed sensor, and may receive information about the area where the current mobility is located based on GPS information. In the present disclosure, the sensor S is a collective term for various sensors, and may serve to collect a variety of information, including the detection of internal and external objects, speed, location, and tilt.

In this way, the controller 600 receives information on the tilt and driving speed of the vehicle body 100, and presence or absence of surrounding obstacles through various sensors S, and if any of the following conditions are met: the tilt of the vehicle body 100 is at or above a set angle, the vehicle's driving speed is at or above a set speed, and surrounding obstacles are present, the controller 600 causes the opening part 110 of the vehicle body 100 to remain closed.

For example, the set angle might correspond to a ground slope of 5° or greater, and the set speed could be a driving speed of 1 km/h or greater. As mentioned earlier, the controller 600 ensures that the driving unit 200 stays coupled to the vehicle body 100 because precise position control of the driving unit 200 may become impossible, or passenger boarding and alighting may become unsafe if the vehicle body 100's tilt exceeds the set angle. In addition, when the driving speed of the vehicle body 100 at or above the set speed, the controller 600 determines that the vehicle is being driven and ensures that the driving unit 200 remains coupled to the vehicle body 100.

Furthermore, when there are obstacles around the mobility, interference with the obstacles or with the passengers may occur when the driving unit 200 moves. Thus, the controller 600 ensures that the driving unit 200 remains coupled to the vehicle body 100 during movement.

Thus, by assessing the information in each situation and controlling the driving unit 200 and the fixing unit 500, the controller 600 determines whether the opening part 110 should be opened or closed, thereby preventing potential safety accidents.

In addition, based on each of the aforementioned information items, the controller 600 may calculate the distance by which the driving unit 200 moves away from the vehicle body 100.

For example, when there are obstacles around the mobility, the driving unit 200 may be moved only to the extent that it does not interfere with the obstacles, allowing the opening part 110 of the vehicle body 100 to open. In the case of a passenger has limited mobility, the driving unit 200 may be moved to the maximum position to secure sufficient space for the passenger to board or alight.

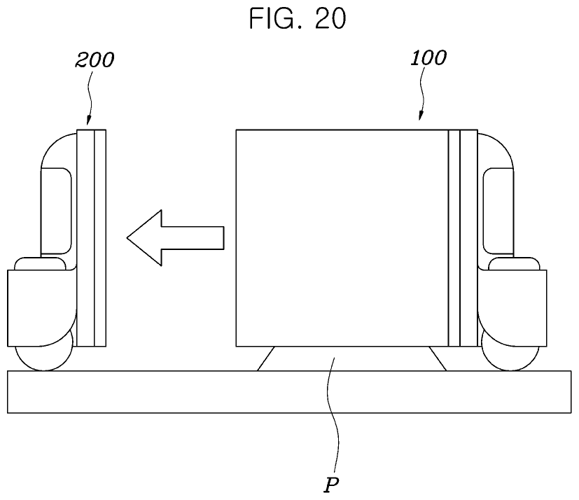

Meanwhile, as illustrated in FIG. 20, when detecting a separation between the vehicle body 100 and the driving unit 200, the controller 600 identifies whether the vehicle body 100 is located at the station P. If the vehicle body 100 is identified to be at the station P, the controller 600 may control all of the fixing units 500 to release fixation and control the driving unit 200 to disengage from the vehicle body 100.

The station P is equipped with facilities for charging the battery in the vehicle body 100 or performing maintenance on it. It may also include equipment to support the vehicle body 100 of the mobility. Accordingly, the controller 600 permits the separation of the vehicle body 100 and the driving unit 200 only when the vehicle body 100 is located at the station P at the time of separation of the vehicle body 100 and the driving unit 200, thereby preventing the vehicle body 100 from losing balance due to a shift in its center of gravity when the driving unit 200 is separated from the vehicle body 100.

Thus, upon the separation of the vehicle body 100 and the driving unit 200, the controller 600 releases all of the fixing units 500 to allow the driving unit 200 to disengage from the vehicle body 100, and allows the driving unit 200 to move completely away from the vehicle body 100. In addition, the controller 600 may control the driving unit 200 to completely move away from the vehicle body 100 while all of the fixing units 500 remain fixed, depending on the status of the vehicle body 100 and the driving unit 200 at the station P.

The smart mobility, which has a separable and couplable structure as described above, is configured to expand or contract. When contracted, the multiple frames overlap each other to ensure overall rigidity, and when expanded, the opening part 110 of the vehicle body 100 opens to allow passengers to board the same, thereby eliminating the need for separate door partitioning and securing a wider entryway.

Moreover, even when the mobility is contracted, it is easy to manufacture the mobility since there is no door partitioning for passenger boarding and alighting, and even when the overall size of the mobility is small, the size of the entrance is secured, improving user convenience.

Although the present disclosure has been described and illustrated with specific embodiments, it will be apparent to those skilled in the art that various improvements and modifications can be made without departing from the technical scope of the disclosure as defined by the appended claims.

What is claimed is:

1. A separable and couplable smart mobility comprising:
a vehicle body having an interior space and an opening part provided on one or both sides of the vehicle body;
a driving unit including a closure part and a driving module, wherein the closure part is configured to match the opening part of the vehicle body, and the driving module is installed in the closure part and configured to move the driving unit;
multiple fixed frames disposed on an inner or an outer surface of the vehicle body and extending in a longitudinal direction;
extension frames detachably connected to the closure part, wherein each extension frame is connected to a corresponding fixed frame and configured to slide along the fixed frame; and
fixing units configured to selectively secure the extension frames to the closure part when the extension frames come into contact with the closure part.

2. The smart mobility of claim 1, wherein the vehicle body includes the opening part positioned on one side of the vehicle body, and a vehicle body driving module is positioned on a side of the vehicle body opposite to the opening part.

3. The smart mobility of claim 1, wherein the multiple fixed frames are spaced apart from each other along a periphery of an inner surface of the vehicle body and each have a hollow bore in the longitudinal direction, and
wherein the extension frames are provided in a same number as the fixed frames and each extend in the longitudinal direction to be inserted into the hollow bore.

4. The smart mobility of claim 3, wherein the extension frames have a length equal to or greater than that of the fixed frames, such that when the extension frames are inserted into the hollow bores, end portions of the extension frames are partially exposed from the fixed frames.

5. The smart mobility of claim 3, wherein the extension frames further include a slider connected to the fixed frames and configured to move linearly along the fixed frames, wherein the slider has a sliding or rolling function.

6. The smart mobility of claim 1, wherein each of the fixed frames includes:
a main support portion extending in the longitudinal direction, fixed to the vehicle body, and having a hollow bore; and
a sub-support portion extending in a peripheral direction of the vehicle body from the main support portion and fixed to the vehicle body.

7. The smart mobility of claim 1, wherein the fixing units each include a fixing part and a connecting part,
wherein the fixing part is provided in one of the closure frame or a corresponding extension frame, and
wherein the connecting part includes:
a pole part provided in a remaining one of the closure part and the extension frame;
a first magnet rotatably provided in the pole part;
a second magnet spaced apart from the first magnet and fixed to the pole part; and
an electromagnet configured to generate a magnetic force when current is applied thereto.

8. The smart mobility of claim 7, wherein the fixing part is made of a magnetically attractable material, including a steel material, and
wherein the first magnet and the second magnet are each configured with a permanent magnet, such that a direction of a magnetic field changes depending on a rotation position of the first magnet.

9. The smart mobility of claim 7, wherein the electromagnet is provided between the first magnet and the second magnet in the pole part, and is configured to adjust a rotation position of the first magnet through generation of the magnetic force.

10. The smart mobility of claim 9, wherein, during the generation of the magnetic force, the electromagnet forms opposite polarities in a direction where the first magnet and the second magnet face each other.

11. The smart mobility of claim 1, wherein the fixing units each include:
a first contact and a second contact provided on the fixing part and the extension frame, respectively;
a pole unit including a first pole part provided with a first permanent magnet extending toward the first contact and a second pole part extending toward the second contact, wherein a second permanent magnet is rotatably provided on the first pole part, and a third permanent magnet is rotatably provided in the second pole part;
a first electromagnet disposed between the first permanent magnet and the second permanent magnet and configured to generate a magnetic force when current is applied; and
a second electromagnet disposed between the first permanent magnet and the third permanent magnet and configured to generate a magnetic force when current is applied.

12. The smart mobility of claim 11, wherein the first contact and the second contact are made of a material magnetically attractable to each of the permanent magnets, including a steel material.

13. The smart mobility of claim 11, wherein the pole unit further includes a partition wall provided between the first pole part and the second pole part, and the partition wall is configured to separate the first and the second pole parts from the second and the third permanent magnets, respectively.

14. The smart mobility of claim 11, wherein the first electromagnet is configured to form different polarities in a direction where the first permanent magnet and the second permanent magnet face each other during the generation of the magnetic force, and
the second electromagnet is configured to form different polarities in a direction where the first permanent magnet and the third permanent magnet face each other during the generation of the magnetic force.

15. The smart mobility of claim 1, wherein a guide extending toward the opening part is positioned at a lower portion of the vehicle body, and
wherein the driving unit has a floor positioned at a lower portion of the closure part, and the floor is connected to the guide and configured to move along the guide.

16. The smart mobility of claim 1, further comprising:
a controller configured to control the driving unit and the fixing units,
wherein the controller is configured to operate the driving unit and the fixing units to open the opening part of the vehicle body based on a user boarding or alighting activity.

17. The smart mobility of claim 16, wherein the controller is configured to:
receive information regarding the user's boarding or alighting direction via communication with a sensor provided on the vehicle body or the user; and
during the user's boarding or alighting, control the fixing unit securing the extension frame located in a passenger boarding or alighting direction among the multiple extension frames to release fixation of the corresponding extension frame, and direct the driving unit to move away from the vehicle body.

18. The smart mobility of claim 16, wherein the controller is configured to:
collect information regarding tilt or driving speed of the vehicle body, or presence of a surrounding obstacle via communication with an external source or a sensor provided on the vehicle body; and
ensure that the opening part of the vehicle body remains in a closed state if any of following conditions are met: the tilt of the vehicle body is at or above a set angle, the driving speed of the vehicle is at or above a set speed, or the surrounding obstacle is detected.

19. The smart mobility of claim 16, wherein the controller is configured to:
collect information regarding tilt or speed of the vehicle body, or presence of a surrounding obstacle via communication with an external source or a sensor provided on the vehicle body; and
determine distance by which the driving unit moves away from the vehicle body based on each piece of information.

20. The smart mobility of claim 16, wherein the controller is configured to:
identify whether the vehicle body is positioned at a station during separation of the vehicle body and the driving unit; and
upon confirming that the vehicle body is positioned at the station, control all of the fixing units to release fixation and direct the driving unit to disengage from the vehicle body.
